(19) United States
(12) Patent Application Publication
(10) Pub. No.: US 2011/0116782 A1
(43) Pub. Date: May 19, 2011

(54) Camera support

(76) Inventor: L. Dean Scott, Lucedale, MS (US)

(21) Appl. No.: 12/591,385

(22) Filed: Nov. 18, 2009

(51) Int. Cl. G03B 17/00

(52) U.S. Cl. 396/428

(57) ABSTRACT

A camera support including a mounting bracket for securement to a tree trunk. The inner end of a multi-armed boom is connected to the mounting bracket. The first arm of the boom is pivotally connected to the mounting bracket such that the outer end of the boom can be selectively yawed from side to side. The second arm of the boom is pivotally connected to the first arm such that the outer end of the boom can be selectively yawed from side to side. The boom's third arm is pivotally connected to the second arm such that the outer end of the boom can be selectively pitched up and down. A fourth arm of the boom is pivotally connected to the third arm such that the outer end of the boom can be selectively rolled over. A camera mount is affixed to the outer end of the boom on the fourth arm.

### FIELD OF THE INVENTION

The present invention relates generally to supports and, more particularly to support brackets that can be adjusted both vertically and horizontally.

### BACKGROUND OF THE INVENTION

Capturing video images in wooded areas is not easy. Lighting conditions are tricky. Ticks and other insects are abundant. The presence of brush makes movement difficult. Uneven ground offers little support for camera tripods. In response to the last problem, devices for securing video cameras to trees have been proposed.

The proposed camera mounting devices are flimsy. They are also difficult to use since they cannot be easily adjusted to support a video camera in a level manner. Also, the proposed devices lack the ability to pan the camera so as to follow moving targets. When the camera is improperly leveled and moved, it often captures skewed and unusable images.

Getting camera equipment into wooded areas often requires carrying. If an area designated for videographic work is a long way from a trailhead, camera equipment might be toted in a backpack for hours or even days. Camera supports, therefore, must be compact in size and lightweight in construction, yet nothing of this sort is commercially available.

### SUMMARY OF THE INVENTION

In light of the problems associated with the known video camera mounting devices, it is a principal object of the invention to provide a camera support that is lightweight and compact in size. My support can be easily carried in a backpack or in hand. After use, the support can be stowed in an out-of-the-way place like a desk drawer, tool box, or vehicle trunk.

It is another object of my invention to provide a camera support of the type described that permits a video camera to be easily secured to an object, such as a tree or the ground. Once secured by the support, a camera can be easily moved to any desired orientation. The support permits the camera to be simultaneously yawed from left to right, pitched up and down, and rolled over. Thus, the camera support is infinitely adjustable over a large range of movement. Once a desired camera position is reached, the support can be locked in place to retain the camera in the desired position.

It is another object of the invention to provide a camera support of the type described that will accommodate different makes and models of cameras.

It is a further object of the invention to provide a camera support that requires minimal training, and no additional tools, for deployment in the field.

It is an object of the invention to provide improved features and arrangements thereof in a camera support for the purposes described which is inexpensive to manufacture, and fully dependable in use.

The foregoing and other objects, features, and advantages of my invention will become readily apparent upon review of the following detailed description of the camera support illustrated in the accompanying drawings.

### BRIEF DESCRIPTION OF THE DRAWINGS

My invention can be more readily understood with reference to the accompanying drawings, in which:

FIG. 1 is a perspective view of a camera support in accordance with the present invention shown secured to a tree trunk in an extended state and supporting a video camera.

FIG. 2 is a perspective view of the camera support of FIG. 1 in a collapsed state and without a mounting bracket.

FIG. 3 is a perspective view of the outer end of the support showing its camera mount.

FIG. 4 is an exploded perspective view of the inner end of the camera support and its mounting bracket.

FIG. 5 is an exploded perspective view of the inner end of the camera support and an alternate mounting bracket.

FIG. 6 is a schematic view showing the relative positions of the elements shown in FIGS. 6A and 6B.

FIG. 6A is a perspective view of the top portion of a camera support having an alternate boom.

FIG. 6B is a perspective view of the bottom portion of a camera support having an alternate boom.

Similar reference characters denote corresponding features consistently throughout the accompanying drawings.

### DETAILED DESCRIPTION OF THE PREFERRED EMBODIMENTS

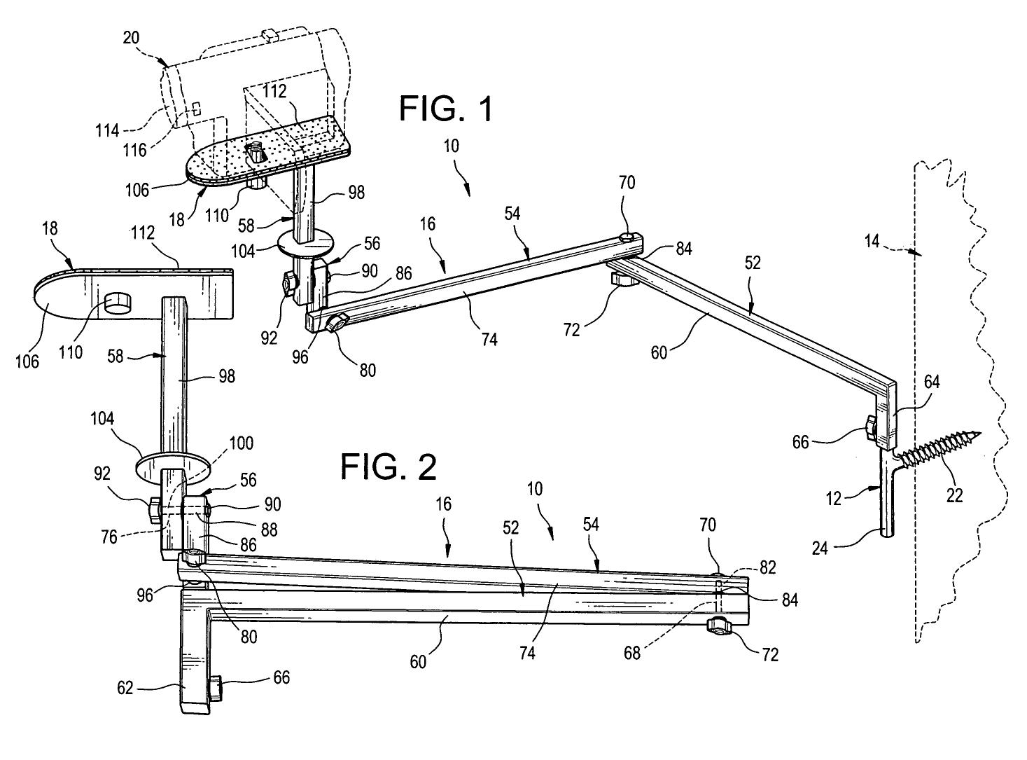

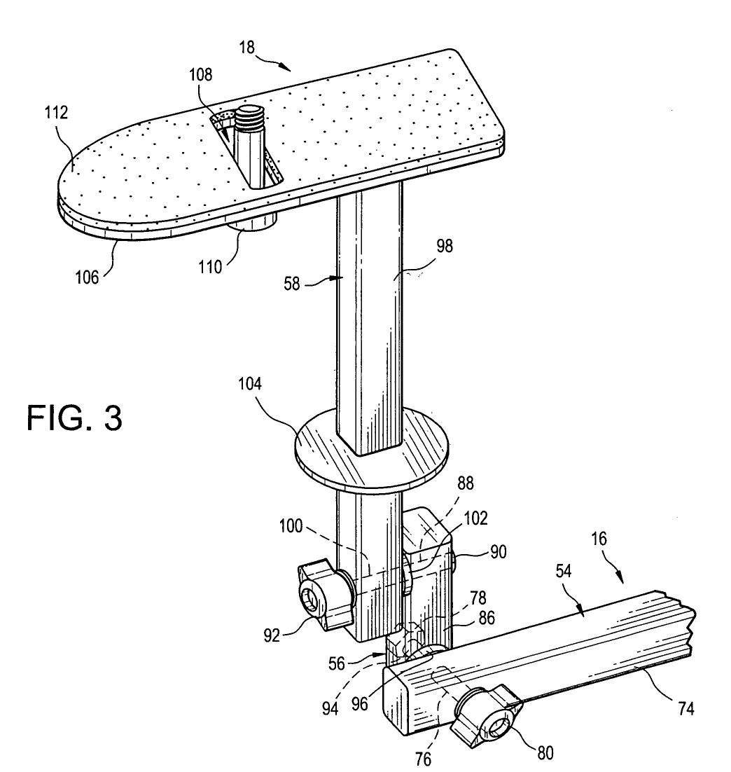

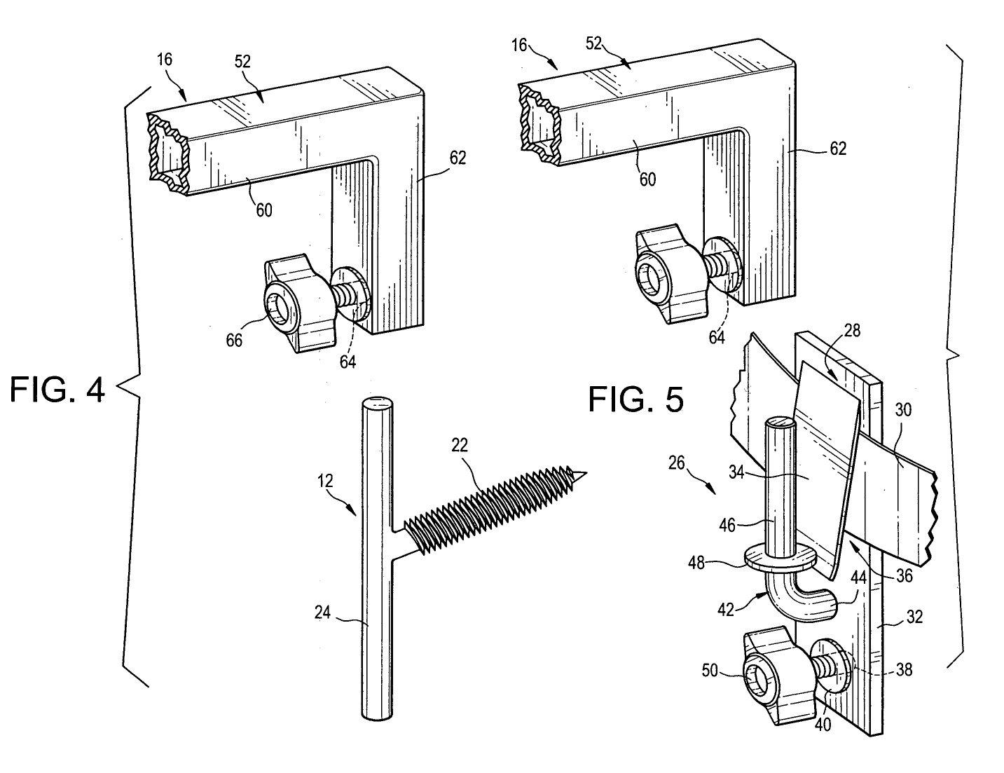

Referring now to FIGS. 1-5, a camera support in accordance with the present invention is shown at 10. Support 10 includes a mounting bracket 12 for releasable securement to a tree trunk 14. The inner end of a boom 16 is releasably fastened to bracket 12. The outer end of boom 16 carries a camera mount 18 to which a video camera 20 is releasably fastened.

Mounting bracket 12 is T-shaped having a screw 22 and a handle 24 that is affixed at its midpoint to the rearward end of screw 22 for applying torque. As shown, screw 22 is a cylindrical rod incised with one or more helical or advancing spiral threads. Also, screw 22 is tapered and pointed at its forward end for the easy penetration of tree trunk 14. Handle 24 is a plain, cylindrical rod having a length that is substantially the same as that of screw 22. Screw 22 is driven into tree trunk 14 by placing its pointed end against tree trunk 14 and, then, turning it by twisting handle 24. With handle 24 being vertically oriented, boom 16 can be readily attached to it.

FIG. 5 shows an alternate mounting bracket 26 for securing camera support 10 tree trunk 14 or a similar thing. Mounting bracket 26 has a base portion 28 through which a tree-encircling belt 30 is extended. Mounting bracket 26 can be secured to tree trunk 14 at any height without damaging tree trunk 14.

Base portion 28 has a rectangular base plate 32 having a rigid tab 34 affixed to both the top and the front thereof. Tab 34 extends downwardly toward the bottom of base plate 32 and forms a narrow slot 36 between itself and base plate 32 for receiving belt 30. Beneath tab 34, a threaded bore 38 is provided in the bottom of base plate 32. A tubular sleeve 40 is affixed to the front of base plate 32 to reinforce base plate 32 adjacent bore 38 and to elongate bore 38. An L-shaped, mounting pin 42 is affixed to the front of base plate 32 between tab 34 and sleeve 40. Pin 42 has a horizontal member 44 that projects forwardly from base plate 32 beyond tab 34 and a vertical member 46 that projects upwardly from the free end of horizontal member 44. A collar 48 is affixed to the vertical member 46 and serves as a stop for the inner end of boom 16. A thumbscrew 50 is threadably engaged with bore 38.

Belt 30 is a strip of webbing with a ratchet-type winder (not shown) affixed to one of its ends. Belt 30 is sized for easy extension through slot 36 and has a length sufficient to extend around tree trunk 14. By ratcheting the winder, the free end of belt 30 is reeled in to pull tight against tree trunk 14. Releasing the ratchet mechanism of the winder frees belt 30 and bracket 26 from tree trunk 14.

Boom 16 has four arms 52, 54, 56 and 58 that are pivotally connected together. Arms 52, 54, 56 and 58 move in such a manner that camera mount 18 can be yawed from side to side, pitched up and down and rolled, much like an airplane in flight. Thus, a user of support 10 is afforded substantial freedom in the positioning of camera 20 on mount 18 while making a movie.

First arm 52 includes a first bar 60 having an inner end and an outer end and a socket member 62 affixed to the inner end so as to provide first arm 52 with an L-shaped profile. Socket member 62 extends downwardly from first bar 60 and is open at its bottom so as to receive one end of handle 24 therein. A threaded bore 64 penetrates socket member 62 and threadably receives a thumbscrew 66. When tightened, thumbscrew 66 clamps the end of handle 24 in socket member 62 thereby preventing first arm 52 from pivoting on handle 24. Loosening thumbscrew 66, however, permits a pivoting movement akin to the yaw of an airplane. Remote from socket member 62, a vertical bore 68 extends through the outer end of first bar 60 and receives therein a first bolt 70 which threadably carries a first, wing nut 72.

Second arm 54 is substantially the same length as first arm 52 and is carried by first arm 52. Second arm 54 includes a second bar 74 having an outer end and an inner end. A horizontal bore 76 passes through the outer end of second bar 54 and receives therein a second bolt 78 which threadably carries a second, wing nut 80. Additionally, a vertical bore 82 passes through the inner end of second bar 74 and is adapted for registration with vertical bore 68. Bolt 70 extends through vertical bore 82 so as to releasably fasten second arm 54 to first arm 52. Tightening wing nut 72 on bolt 70 locks bars 60 and 74 together. Loosening wing nut 72, on the other hand, permits bars 60 and 74 to pivot about a vertical axis defined by bolt 70. This pivoting action serves to yaw camera mount 18 and camera 20 carried thereby. A washer 84 positioned on first bolt 70 between bars 60 and 74 prevent bars 60 and 74 from binding when pivoted relative to one another.

Third arm 56 measures about one-sixth the length of first arm 52 and is carried by second arm 54. Third arm 56 includes a third bar 86 having an outer end and an inner end. A vertical bore 88 passes through the outer end of third bar 86 and receives therein a third bolt 90 which threadably carries a third, wing nut 92. Also, a horizontal bore 94 passes through the inner end of third bar 86 and is adapted for registration with horizontal bore 76. Second bolt 78 extends through horizontal bore 94 so as to releasably fasten third arm 56 to second arm 54. Tightening wing nut 80 on second bolt 78 locks bars 74 and 86 together, and loosening wing nut 80, allows bars 74 and 86 to pivot about a horizontal axis defined by second bolt 78. This pivoting action serves to pitch camera mount 18, and camera 20 carried thereby, up and down. A washer 96 positioned on second bolt 78 between bars 74 and 86 prevent bars 74 and 86 from binding when pivoted relative to one another.

Fourth arm 58 is about one-half as long as first arm 52 and includes a fourth bar 98 having both an outer end and an inner end. Camera mount 18 is affixed to the outer end of fourth bar 98. A vertical bore 100 passes through the inner end of fourth bar 98 and is adapted for registration with vertical bore 88 in third bar 86. Third bolt 90 extends through vertical bore 100 so as to releasably fasten fourth arm 58 to third arm 56. Tightening wing nut 92 on third bolt 90 locks bars 86 and 98 together, and loosening wing nut 92, allows bars 86 and 98 to pivot about a horizontal axis defined by third bolt 90. This pivoting action serves to roll camera mount 18 and camera 20. A washer 102 positioned on third bolt 90 between bars 86 and 98 prevent bars 86 and 98 from binding when pivoted relative to one another.

For user comfort, a gauntlet 104 is affixed to fourth bar 98 adjacent bolt 90. Gauntlet 104 is a ring that extends around bar 98 and serves as a rest for the hand of a user which is expected to manipulate boom 16 by grasping bar 98 above gauntlet 104 and applying pushing and pulling forces to position camera 20 at a desired orientation. Gauntlet 104 also prevents the hand of a user from inadvertently turning wing nut 92.

Camera mount 18 comprises a flat plate 106 that is affixed atop fourth arm 58. Plate 106 is provided with a transverse slot 108 remote from fourth arm 58 through which a thumbscrew 110 passes upwardly. Thumbscrew 110 is turned into an internally threaded socket (not shown) provided in the bottom of camera 20 to releasably secure camera 20 to mount 18. To dampen vibrations and ensure a firm grip of mount 18 upon camera 20, a resilient, foam rubber pad 112 is affixed to the top of plate 106.

Video camera 20 is attached by mount 18 to the outer, free end of boom 16. Camera 20 is digital in type and conventional in construction. Camera 20 has a lens 114 for gathering light and a microphone 116 for capturing sound. Light passing through lens 114 contacts an imager (not shown) that converts the incident light into an electronic video signal which is delivered to a recorder (not shown) for storage and subsequent playback. Microphone 116 is an acoustic-to-electric transducer that converts sound into an electronic signal that is delivered to the recorder for simultaneous playback with the video signal. Camera 20, of course, can be any light-gathering, optical instrument

The use of camera support 10 is straightforward. First, mounting bracket 12 is placed at a suitable height adjacent tree trunk 14 and fastened thereto by turning screw 22 with handle 24. Then, socket member 62 is positioned atop one end of handle 24 and fixed there by tightening thumbscrew 66. (Alternately, mounting bracket 26 is fastened to tree trunk 14 at a convenient height by means of belt 30 and socket member 62 is positioned on vertical member 46 of mounting pin 42. Afterward, thumbscrew 66 is tightened to snugly grip vertical member 46.) Now, camera 20 is attached to mount 18 by tightening thumbscrew 110 inserted into camera 20. Once camera 20 is energized, arms 52, 54, 56 and 58 can be moved about to easily, comfortably and stably point camera 20 in any direction for recording video or still images and audio. Only a few minutes are required to set up support 10.

While carried by support 10, camera 20 can be turned in any orientation. It can be yawed from side to side, pitched up and down and rolled simply by manipulating boom 16 while grasping fourth arm 58 above gauntlet 104. If the user desires to fix the position of camera 20 on boom 16, he need merely tighten wing nuts 72, 80 and 92 to lock the positions of arms 52, 54, 56 and 58 relative to one another. Loosening wing nuts 72, 80 and 92, of course, permits 52, 54, 56 and 58 to move with a desired amount of freedom.

Taking down support 10 requires less time than setting it up. First, camera 20 is disconnected from mount 18 by loosening thumbscrew 110. Then, support 10 is removed from tree trunk 14 by reversing the steps outlined in the previous paragraph. After arms 52, 54, 56 and 58 are folded upon one another, support 10 can be transported and stored in a compact state. Support 10 is ready for immediate reuse.

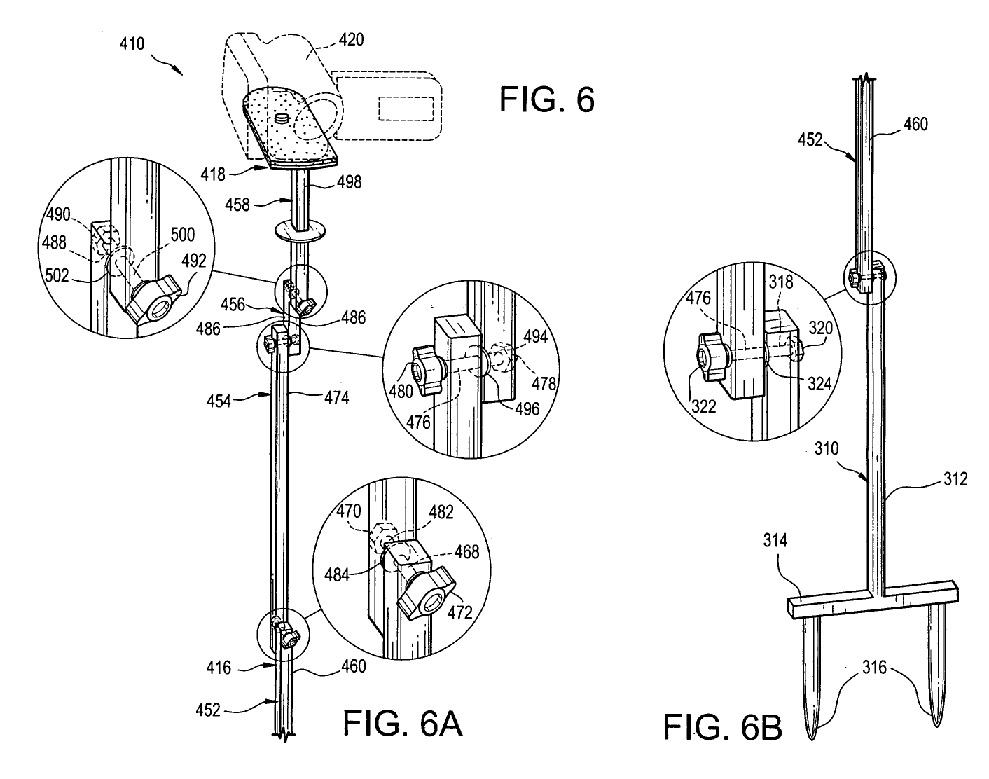

An alternate camera support 410 is illustrated in FIG. 6. Support 410 is substantially identical to support 10 except that mounting brackets 12 and 26 used therewith are replaced by a boom arm 310 having integral mounting features described hereinbelow. These mounting features permit support 410 to be freestanding.

Support 410 includes a boom 416 that supports a camera mount 418 at its free end. Boom 416 has five arms 310, 452, 454, 456, and 458 that are pivotally connected together and permit camera mount 418 to be yawed from side to side, pitched up and down and rolled. A user of support 410, like support 10, is afforded substantial freedom in the positioning of camera 420 on mount 418.

Auxiliary arm 310 has an auxiliary bar 312 with an inner end and an outer end. A crossbar 314 is affixed at its midpoint to the inner end of auxiliary bar 312. The outer ends of two, ground-penetrating spikes 316 are affixed to crossbar 314 in a spaced apart relationship and provide auxiliary arm 312 with a configuration of a fork with spikes 316 serving as tines and bar 312 acting like a handle. Remote from crossbar 314, a horizontal bore 318 extends through the outer end of auxiliary bar 312 and receives therein an auxiliary bolt 320 which threadably carries an auxiliary, wing nut 322.

First arm 452 is substantially the same length as auxiliary arm 310 and is carried by auxiliary arm 310. First arm 310 includes a first bar 460 having an inner end and an outer end. A vertical bore 468 extends through the outer end of first bar 460 and receives therein a first bolt 470 which threadably carries a first, wing nut 472. A horizontal bore 476 passes through the inner end of first bar 460 and is adapted for registration with horizontal bore 318 in auxiliary bar 312. Bolt 320 extends through horizontal bore 476 so as to releasably fasten first arm 452 to auxiliary arm 310. Tightening wing nut 322 on bolt 320 locks bars 312 and 460 together. Loosening nut 322, however, permits bars 312 and 460 to pivot about a vertical axis defined by bolt 320. This pivoting action serves to pitch up and down camera mount 418 and camera 420 carried thereby. A washer 324 positioned on first bolt 320 between bars 312 and 460 prevents bars 312 and 460 from binding when pivoted relative to one another.

Second arm 454 is substantially the same length as first arm 452 and is carried by first arm 452. Second arm 454 includes a second bar 474 having an outer end and an inner end. A horizontal bore 476 passes through the outer end of second bar 474 and receives therein a second bolt 478 which threadably carries a second, wing nut 480. Additionally, a vertical bore 482 passes through the inner end of second bar 474 and is adapted for registration with vertical bore 468 in first bar 460. Bolt 470 extends through vertical bore 482 so as to releasably fasten second arm 454 to first arm 452. Tightening wing nut 472 on bolt 470 locks bars 460 and 474 together. Loosening wing nut 472, however, permits bars 460 and 474 to pivot about a vertical axis defined by bolt 470. This pivoting action serves to yaw camera mount 418 and camera 420 carried thereby. A washer 484 positioned on first bolt 470 between bars 460 and 474 prevent bars 460 and 474 from binding when pivoted relative to one another.

Third arm 456 measures about one-sixth the length of first arm 452 and is carried by second arm 454. Third arm 456 includes a third bar 486 having an outer end and an inner end. A vertical bore 488 passes through the outer end of third bar 486 and receives therein a third bolt 490 which threadably carries a third, wing nut 492. Also, a horizontal bore 494 passes through the inner end of third bar 486 and is adapted for registration with horizontal bore 476 in second bar 474. Second bolt 478 extends through horizontal bore 494 so as to releasably fasten third arm 456 to second arm 454. Tightening wing nut 480 on second bolt 478 locks bars 474 and 486 together, and loosening wing nut 480, allows bars 474 and 486 to pivot about a horizontal axis defined by second bolt 478. This pivoting action serves to pitch camera mount 418, and camera 420 carried thereby, up and down. A washer 496 positioned on second bolt 478 between bars 474 and 486 prevent bars 474 and 486 from binding when pivoted relative to one another.

Fourth arm 458 has a length that is about one half that of first arm 452 and includes a fourth bar 498 having both an outer end and an inner end. Camera mount 418 is affixed to the outer end of fourth bar 498. A vertical bore 500 passes through the inner end of fourth bar 498 and is adapted for registration with vertical bore 488 in third bar 486. Third bolt 490 extends through horizontal bore 500 so as to releasably fasten fourth arm 458 to third arm 456. Tightening wing nut 492 on third bolt 490 locks bars 486 and 498 together, and loosening wing nut 492, allows bars 486 and 498 to pivot about a horizontal axis defined by third bolt 490. This pivoting action serves to roll camera mount 418 and camera 420. A washer 502 positioned on third bolt 490 between bars 486 and 498 prevents bars 486 and 490 from binding when pivoted relative to one another.

The use of camera support 410 is straightforward. First, auxiliary arm 310 is positioned at a desired spot on the ground and spikes 316 are driven into the earth by stepping on crossbar 314. Next, arms 452, 454, 456 and 458 are sequentially elevated above auxiliary arm 310 and secured in place by tightening wing nuts 322, 472, 480 and 492. Then, camera 420 is attached to mount 418. Once camera 420 is energized, arms 452, 454, 456 and 458 are moved about to easily, comfortably and stably point camera 420 in any direction for recording video or still images and audio. Only a few minutes are required to set up support 410.

While carried by support 410, camera 420 can be turned in any orientation. It can be yawed from side to side, pitched up and down and rolled simply by manipulating boom 416 while grasping fourth arm 458. If the user desires to fix the position of camera 420 on boom 416, he need merely tighten wing nuts 322, 472, 480 and 492 to lock the positions of arms 452, 454, 456 and 458. Loosening wing nuts 322, 472, 480 and 492 permits arms 452, 454, 456 and 458 to move with a desired amount of freedom.

Taking down support 410 requires minimal time. First, camera 420 is disconnected from mount 418. Then, support 410 is disengaged from the ground by reversing the steps outlined in the previous paragraph. After arms 310, 452, 454, 456 and 458 are folded upon one another, support 410 can be transported and stored in a compact state. Support 410 is ready for immediate reuse.

While camera supports 10 and 410 have been described with a high degree of particularity, it will be appreciated by those skilled in the field that modifications can be made to them. For example, the lengths and numbers of the arms forming booms 16 and 416 can be varied as a matter of design choice. Making arms 56 and 58 longer, however, might be make support 10 cumbersome to use since pitching and rolling movements of camera 20 must take place within a comfortable range of heights within the reach of a user. Also, the various orientations of the bores and bolts that permit the pitching, yawing and rolling movements of mounting plates 18 and 418 can also be varied in accordance with the needs of a user. Of course, any number of spikes 316 can be used to attach support 410 to the ground with greater numbers offering greater stability and fewer numbers providing lightness. Therefore, it is to be understood that my invention is not limited merely to camera supports 10 and 410, but encompasses any and all camera supports within the scope of the following claims.

1. A camera support, comprising:
a mounting bracket for securement to a tree trunk;
a boom having an inner end being connected to said mounting bracket and an outer end remote from said inner end, said boom including:
a first arm being pivotally connected to said mounting bracket such that said outer end of said boom can be selectively yawed from side to side;
a second arm being pivotally connected to said first arm such that said outer end of said boom can be selectively yawed from side to side;
a third arm being pivotally connected to said second arm such that said outer end of said boom can be selectively pitched up and down; and,
a fourth arm being pivotally connected to said third arm such that said outer end of said boom can be selectively rolled over; and,
a camera mount being affixed to said outer end of said boom on said fourth arm.

2. The camera support according to claim 1 wherein
said mounting bracket includes:
a screw for penetrating a tree trunk; and,
a handle, being a cylindrical rod, affixed at the middle thereof to said screw for rotating said screw; and,
said first arm includes:
a socket member rotatably and releasably positioned on said handle; and,
a first bar being affixed to, and extending from, the top of said socket member.

3. The camera support according to claim 1 wherein said mounting bracket
includes:
a base plate for engaging a tree trunk;
a tab being affixed to said base plate and extending outwardly and downwardly therefrom so as to form a slot between itself and said base plate;
a tree-encircling belt extending through said slot;
a mounting pin being affixed to, and extending outwardly and upwardly from, said base plate remote from said tab; and,
said first arm includes:
a socket member rotatably and releasably positioned on said mounting pin; and,
a first bar being affixed to, and extending from, the top of said socket member.

4. A camera support, comprising:
a boom having an inner end and an outer end remote from said inner end, said boom including:
an auxiliary arm having:
a crossbar,
an auxiliary bar being affixed to said crossbar so as to project upwardly therefrom; and,
a spike being affixed to said crossbar so as to project downwardly therefrom, said spike having said inner end of said boom;
a first arm being pivotally connected to said auxiliary bar such that said outer end of said boom can be selectively pitched up and down;
a second arm being pivotally connected to said first arm;
a third arm being pivotally connected to said second arm such that said outer end of said boom can be selectively pitched up and down; and,
a fourth arm being pivotally connected to said second arm such that said outer end of said boom can be selectively rolled over, said fourth arm having said outer end of said boom; and,
a camera mount being affixed to said outer end of said boom on said fourth arm.
